(19) United States
(12) Patent Application Publication
(10) Pub. No.: US 2025/0153313 A1
(43) Pub. Date: May 15, 2025

(54) WORKPIECE CARRIER FRAME AND WORKPIECE CARRIER FRAME SYSTEM

(71) Applicant: ZELL Systemtechnik GmbH, Ehingen-Volkersheim (DE)

(72) Inventor: Ingo ZELL, Ehingen-Volkersheim (DE)

(73) Assignee: ZELL Systemtechnik GmbH, Ehingen-Volkersheim (DE)

(21) Appl. No.: 18/833,000

(22) PCT Filed: Feb. 22, 2023
(86) PCT No.: PCT/EP2023/054464

§ 371 Date: Jul. 25, 2024

(30) Foreign Application Priority Data
Feb. 22, 2022 (DE) 10 2022 104 192.1

(51) Int. Cl. B25B 11/00

(52) U.S. Cl. CPC B25B 11/00

(57) ABSTRACT

A workpiece carrier frame includes frame corner modules, each including an inner element and an outer element; and at least one module frame that laterally surrounds an interior of the workpiece carrier frame, wherein the frame corner modules are arranged in corner regions of the workpiece carrier frame, such that the inner element and the outer element of each frame corner module are arranged on the inner side or the outer side of the at least one module frame, and the inner element and the outer element of the frame corner module are detachably connected to one another and the at least one module frame runs between the inner element and the outer element.

The invention relates to a workpiece carrier frame and to a workpiece carrier frame system having multiple workpiece carrier frames.

A workpiece carrier basket serves to make one or more workpieces available and to hold them, so that the workpieces can be passed to one or more production stations and processed there and/or can be transported between the production stations and/or stored between the production steps. In the production stations, production steps such as washing, mechanical processing or thermal hardening can be carried out.

A conventional workpiece carrier basket comprises a frame and a carrier bottom. Workpiece holders are arranged on the carrier bottom, by means of which holders the workpieces can be held in a desired position and grouped.

Changes in the production process can lead to the result that the entire workpiece carrier basket must be replaced. This replacement is connected with effort and costs.

DE 2 161 652 A shows a transport container having a cage consisting of angle bars. The side surfaces are closed off by means of grid plates. In one exemplary embodiment, further angle bars are clamped onto the outside of the cage, into which bars the grid plates can be pushed.

DE 10 2007 048 541 A1 shows hand baskets such as those used while shopping, on which baskets an EAS tag is provided in a housing. Two rods of the wire basket run through the housing, which has a front side and a back side.

DE 80 18 781 U1 shows transport containers that can be stacked in spite of their different sizes.

The task arises of providing an approach for a workpiece carrier basket that saves material and is more flexible.

This task is accomplished by means of a workpiece carrier frame for a workpiece carrier basket having the characteristics of claim 1 or of claim 15. Furthermore, a workpiece carrier frame system having multiple workpiece carrier frames is provided.

The workpiece carrier frame is provided with a plurality of frame corner modules, each comprising an inner element and an outer element and at least one module frame that laterally encloses the interior of the workpiece carrier frame. The frame corner modules are arranged in corner regions of the workpiece carrier frame, so that the inner element and the outer element of each frame corner module are arranged on the inner side and the outer side, respectively, of the at least one module frame, and the inner element and the outer element of the frame corner module are releasably connected to one another, and the at least one module frame runs between the inner element and the outer element.

The workpiece carrier frame forms the circumferential side edge of a modular workpiece carrier basket. The workpiece carrier frame also has a modular structure and can be disassembled into its components again after having been assembled.

The modular workpiece carrier frame comprises a plurality of frame corner modules and at least one module frame. These components are releasably assembled as a workpiece carrier frame, wherein the size of the workpiece carrier frame can be modified, in a simple manner, by means of replacement of the module frame. A carrier bottom can be inserted into the workpiece carrier frame so as to form a workpiece carrier basket for holding workpieces. The workpiece carrier basket can be adapted, in a simple manner, to a changed production process by means of replacement of the carrier bottom.

The frame corner modules form the corner regions of the workpiece carrier frame and are connected by means of the module frame. The number of frame corner modules is at least three, ideally four. The module frame defines the size of the workpiece carrier frame, since it predetermines the size and the progression of the side circumference. The frame corner modules extend transverse to the frame. The side regions between the corner regions are formed by the at least one module frame that runs through the frame corner modules in the corner regions. The module frame has a polygonal shape, preferably a rectangular shape, so that the workpiece carrier frame also has a rectangular shape with four corner regions. The module frame can have a closed frame shape and can be formed, for example, from a metal rod, in particular a steel rod, that is bent to form a rectangle, and the ends of which are welded. The rod can have a round or a polygonal cross-section.

The workpiece carrier frame is mounted in that an inner element and an outer element, in each instance, are arranged in the corners of the at least one module frame, on the inside and the outside, respectively, of the module frame, joined together, that the module frame runs between them, and they are releasably connected to one another. “On the inside” is the side that faces the frame interior. “On the outside” is the side facing away from the frame interior. The inner element forms an inner corner region of the workpiece carrier frame, and the outer element forms an outer corner of the workpiece carrier frame.

An alternative workpiece carrier frame comprises a plurality of side modules that each comprise an inner element and an outer element and at least one module frame, which encloses an interior of the workpiece carrier frame laterally, wherein the side modules are arranged in side regions of the workpiece carrier frame, so that the inner element and the outer element of each side module are arranged on the inside and on the outside, respectively, of the at least one module frame, and the inner element and the outer element of the side module are releasably connected to one another, and the at least one module frame runs between the inner element and the outer element.

The side regions are straight regions of the at least one module frame between two adjacent corner regions. In the case of a rectangular module frame, for example, a side module can be provided, in each instance, on the longitudinal and transverse sides of the at least one module frame. It is advantageous if more side modules are provided on the longitudinal sides. The alternative workpiece carrier frame is assembled in that an inner element and an outer element, in each instance, are arranged at the side regions of the at least one module frame, on the inside and on the outside, respectively, of the module frame, joined together, that the module frame runs between them, and they are releasably connected to one another. Side modules and frame corner modules can be summarized using the term “edge modules.”

The workpiece carrier frames the idea that they are composed of at least one module frame and edge modules of at least one type, whether these are frame corner modules or side modules, so as to form a stable and preferably stackable workpiece carrier frame. In one workpiece carrier frame, edge modules are at least provided in the corner regions as frame corner modules. In another workpiece carrier frame, edge modules are provided at least as side modules in the side regions. Of course, there are also embodiments in which both frame corner modules and side modules are provided.

It is advantageous if two module frames are provided in the workpiece carrier frame, so as to form a stable workpiece carrier frame in spite of less material expenditure. A first module frame and a second module frame are arranged one on top of the other. The inner elements and the outer elements each have an upper and a lower region, wherein the first module frame runs between the upper regions of the inner elements and the outer elements, and the second module frame runs between the lower regions of the inner elements and the outer elements.

In one embodiment of the workpiece carrier frame having frame corner modules, at least one side module is provided, which comprises an inner element and an outer element. The side module is arranged in a side region that extends between two adjacent corner regions, so that the at least one module frame runs between the inner element and the outer element of the side module. It is advantageous if two side modules are provided on the longitudinal sides of the rectangular workpiece carrier frame. Nevertheless, providing side modules on the workpiece carrier frame having frame corner modules is optional. They improve the stability of the workpiece frame and, in particular, facilitate stacking of the workpiece frames. The side module, just like the frame corner modules, can be formed from plastic. It is advantageous if the inner elements and the outer elements are one-piece plastic parts. The form of the inner elements and outer elements of the side modules differs from the form of the inner elements and outer elements of the frame corner modules.

Alternatively, in one embodiment of the workpiece carrier frame having side modules, one or more frame corner modules can optionally be provided.

The frame corner modules and/or the side modules have a continuous recess for the module frame, which recess is formed by means of channels in the inner element and in the outer element, which channels face one another. When the inner element and the outer element are joined together, the channels form the recess in which the module frame runs. A channel having a having a semi-circular cross-section in the outer element and a channel having a semi-circular cross-section in the inner element can thereby form a recess having a circular cross-section.

The inner element and the outer element can be connected, in a simple manner, using releasable connection means, in particular connection means that can be screwed together, for example screws and screw nuts.

The frame corner modules and/or the side modules have a support, in each instance, in one embodiment, so that when the workpiece carrier frame has been assembled, a carrier bottom can be set onto the supports. When the workpiece carrier frame has been assembled, the supports project into the frame interior. In the case of a carrier bottom having a size that corresponds to the frame interior, supports on the frame corner modules are sufficient to hold the carrier bottom. In the case of multiple carrier bottoms arranged next to one another, supports on the side modules are also required, so as to hold the carrier bottom. In the case of a workpiece carrier frame that has only side modules, these hold the carrier bottom.

It is advantageous if the workpiece carrier frame can be stacked, so that workpiece carrier baskets that comprise workpiece carrier frames can also be stacked, in that their workpiece carrier frames are set onto one another and secured to prevent them from sliding off to the side. The workpiece carrier frame has a first stacking edge formed by the top sides of the frame corner modules and/or of the side modules, and a second stacking edge formed by the bottom sides of the frame corner modules and/or of the side modules. The first and the second stacking edge correspond to one another, so that when the workpiece carrier frames are stacked, they engage into one another and prevent sliding off to the slide. However, not just workpiece carrier frames having the same size can be stacked, but rather also workpiece carrier frames of different sizes, in the case of which small workpiece carrier frames can be stacked next to one another on a large workpiece carrier frame. Thus, for example, two small workpiece carrier frames can be stacked next to one another on a workpiece carrier frame having double their size. The top sides of the side modules of the large workpiece carrier frame support the bottom sides of the frame corner modules of the stacked small workpiece carrier frames.

In the case of one embodiment, the outer element and the inner element of the frame corner module are arranged offset relative to one another, in such a manner that a region of the outer element that projects beyond the inner element on the top side forms an upwardly projecting edge region of the first stacking edge, and a region of the inner element that projects beyond the outer element on the bottom side forms a bottom engagement of the second stacking edge. The bottom engagement of a stacked frame corner module, when stacked, engages next to the upwardly projecting edge region of a further frame corner module and is supported by its inner element.

In one embodiment, the outer element and the inner element of the side module are arranged offset relative to one another, in such a manner that a region of the outer element that projects beyond the inner element on the top side forms an upwardly projecting edge region of the first stacking edge. The bottom engagement of a frame corner module of a smaller workpiece frame, when stacked, engages next to the upwardly projecting edge region of the side element of the larger workpiece carrier frame and is supported by the inner element of the side element. When workpiece carrier frames having the same size are stacked, the bottom engagement of a side module engages next to the upwardly projecting edge region and is supported by the inner element of a further side element.

A workpiece carrier frame system comprises a plurality of workpiece carrier frames. First workpiece carrier frames have a module frame having a first size. Second workpiece carrier frames have a module frame having a second size. At least two of the first workpiece carrier frames can be stacked next to one another on one of the second workpiece carrier frames. Workpiece carrier baskets having such module frames of different sizes can be stacked in the same manner. The workpiece carrier frame system can comprise further workpiece carrier frames having a module frame having a further size, so that workpiece carrier baskets of different sizes can be combined and stacked.

In the following, some exemplary embodiments will be explained in greater detail, using the drawing. The figures show:

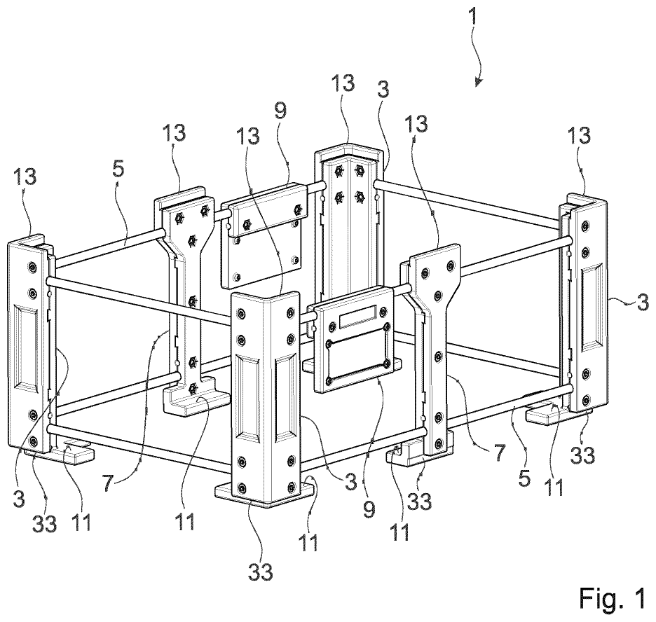

FIG. 1 an exemplary embodiment of a workpiece carrier frame,

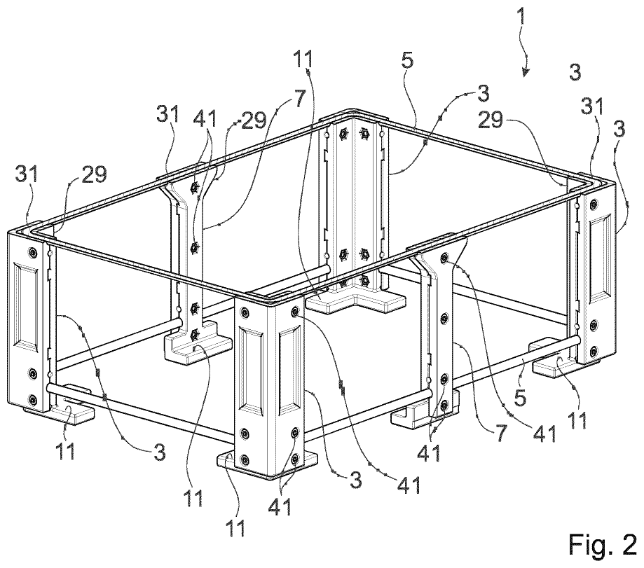

FIG. 2 a section through the workpiece carrier frame,

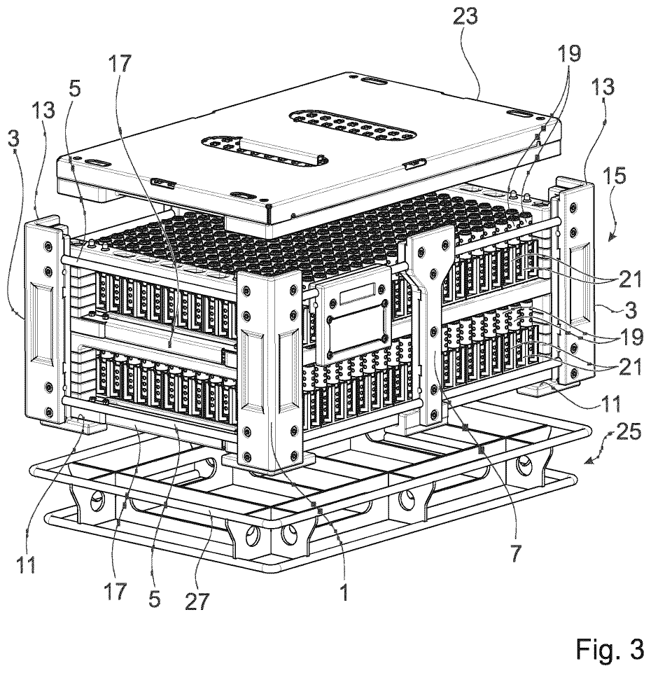

FIG. 3 an exemplary embodiment of a workpiece carrier basket,

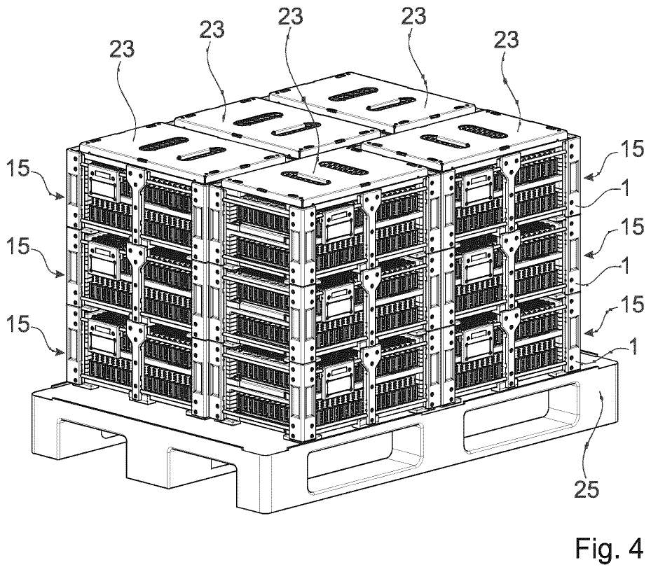

FIG. 4 an exemplary embodiment having multiple workpiece carrier baskets,

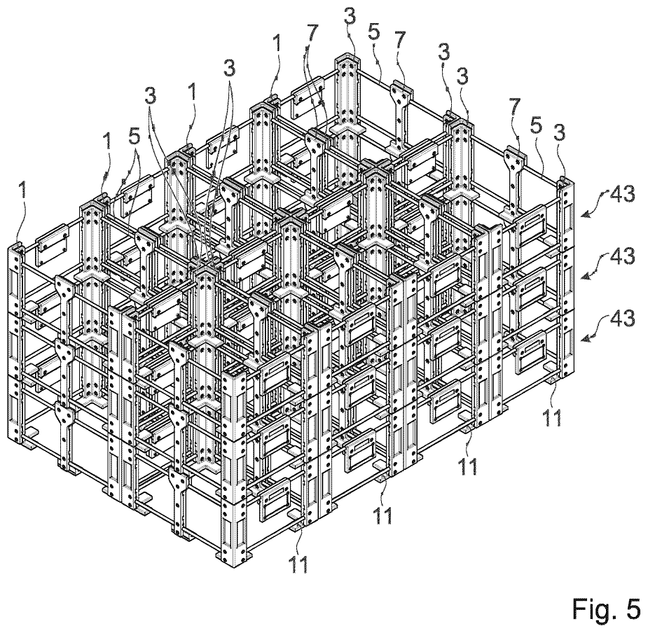

FIG. 5 a further exemplary embodiment having multiple workpiece carrier baskets,

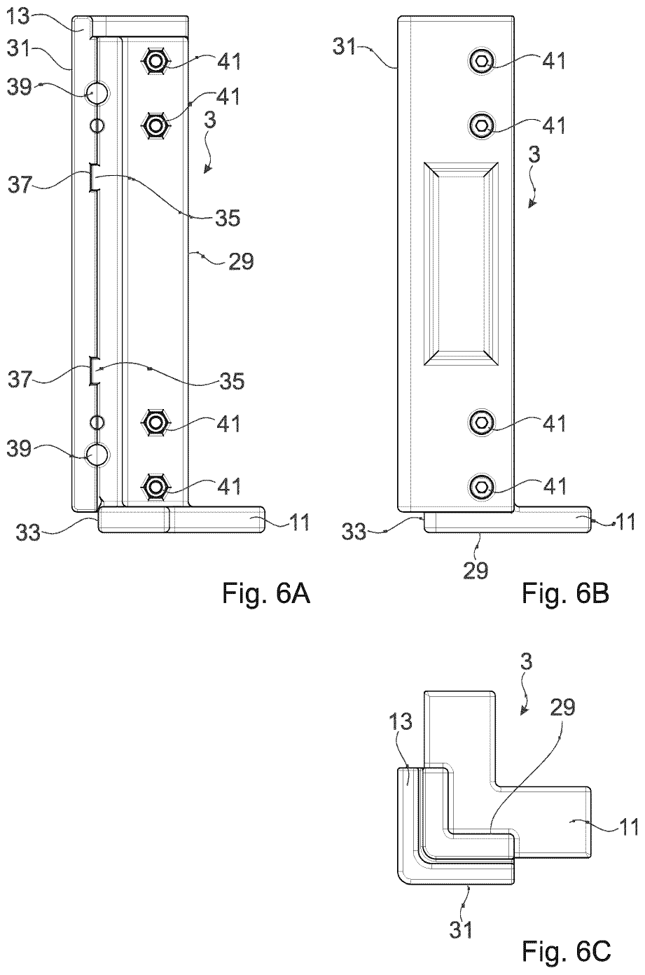

FIGS. 6A, 6B, 6C an exemplary embodiment of a frame corner module, and

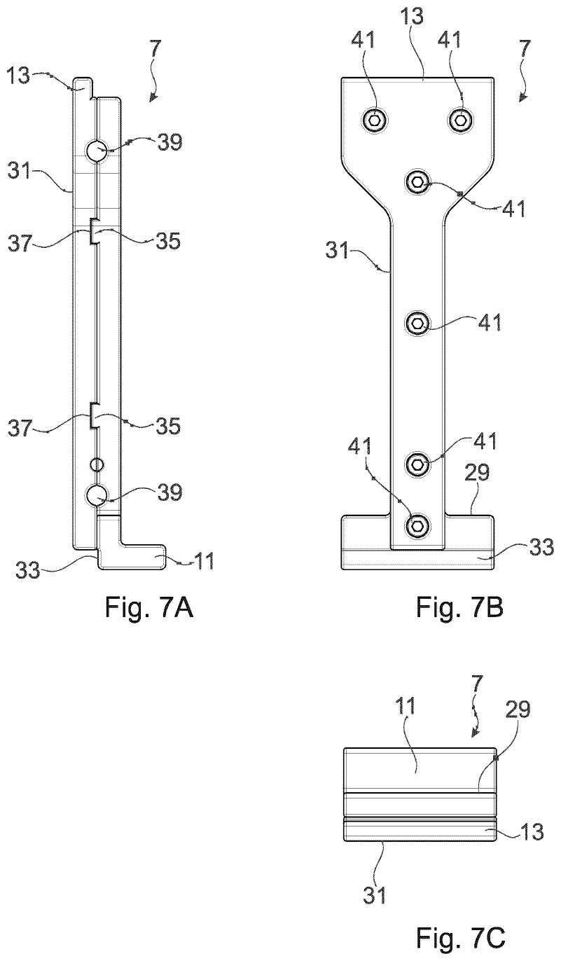

FIGS. 7A, 7B, 7C an exemplary embodiment of a side module.

In the figures, components that are the same or functionally equivalent are given the same reference numbers.

FIG. 1 shows an exemplary embodiment of a workpiece carrier frame 1 in a three-dimensional representation. Such a workpiece carrier frame 1 forms the circumferential side edge of a workpiece carrier basket 15.

The modular workpiece carrier frame 1 comprises four frame corner modules 3 as well as a first and a second module frame 5, which are arranged one on top of the other. The workpiece carrier frame 1 is rectangular and has four corner regions. The frame corner modules 3 are arranged in the corner regions of the workpiece carrier frame 1 and extend transverse to the planes in which the module frames 5 are arranged. The module frames 5 run through the frame corner modules 3. The workpiece carrier frame 1 furthermore has four side regions that extend between adjacent corner regions. Two side regions are opposite longitudinal side regions, and two side regions are opposite width side regions that are shorter than the longitudinal side regions. In this exemplary embodiment, the length ratio of the longitudinal sides to the width sides is 3:2.

Straight sections of the module frames 5 run in the side regions. In the longitudinal side regions, a side module 7 is provided, in each instance, through which the module frames 5 run.

A label 9, through which at least one of the module frames 5 runs, is provided on at least one of the side regions. On the label 9, information about the owner of the workpiece carrier basket 15, its contents or planned production steps, for example, can be indicated.

Both on the frame corner modules 3 and on the side modules 7, a support 11 that projects into the frame interior is provided, in each instance, onto which support a carrier bottom 17 (not shown in FIG. 1) with workpiece carriers 21 can be set. By means of replacement of the carrier bottom 17 in the workpiece carrier frame 1, a workpiece carrier basket 15 formed by a carrier bottom 17 and a workpiece carrier frame 1 can be modified in a simple manner.

The workpiece carrier frame 1 can be stacked, so that a stack composed of multiple workpiece carrier baskets 15 is formed, in that their workpiece carrier frames 1 are set on top of one another. The stacked workpiece carrier baskets 1 are secured to prevent them from slipping off to the side, by means of stacking edges. A first stacking edge is formed by the top sides of the frame corner modules 3 and of the side modules 7, and a second stacking edge is formed by the bottom sides of the frame corner modules 3 and of the side modules 7. The stacking edges engage into one another with shape fit, so that the second stacking edge is supported by the first stacking edge from below, and the first edge runs around the second edge around the outside.

The top sides have an edge region 13 that projects upward as a first stacking edge. The bottom sides have a second stacking edge that is formed by means of a region that projects downward as a bottom engagement 33. The bottom engagement 33 engages into the inside of the edge region 13 when the workpiece carrier frames 1 are stacked. Thereby the top sides and the bottom sides of the frame corner modules 3 and of the side modules 7 form corresponding circumferential stacking edges, but these are not continuous.

FIG. 2 shows the workpiece carrier frame 1 in a three-dimensional sectional representation, wherein the section runs through the upper module frame 5.

The module frames 5 are configured as closed metal frames. It is advantageous if the module frames 5 are configured in one piece. In one embodiment, the module frames 5 are made of steel and have a diameter of 8 mm with a round cross-section. The module frames 5 can be formed, in each instance, by means of a steel rod bent in a rectangular shape, the ends of which are welded together. In an alternative exemplary embodiment, the module frame 5 has a gap. In a further exemplary embodiment, the module frame 5 is formed by means of four rods that are connected to one another, in particular welded to one another. Such rods can have a rectangular, in particular a square cross-section. Because of the module frames 5, the workpiece carrier frame 1 is very stable.

In FIG. 2, it can be seen that both the frame corner modules 3 and the side modules 7 each comprise an inner element 29 and an outer element 31, which elements are connected to one another. The inner element 29 and the outer element 31 are arranged on the inside and on the outside, respectively, of the module frames 5, so that the module frames 5 run between the inner element 29 and the outer element 31. The assembled inner elements 29 and outer elements 31 are releasably connected to one another by means of connection means 41, in particular connection means that can be screwed together.

By means of module frames 5 having different sizes, workpiece carrier frames 1 having different sizes can be formed from the same frame corner modules 3 and side modules 7.

The storage space for the individual components from which workpiece carrier frames 1 can be assembled is less than the storage space for assembled workpiece carrier frames 1. Workpiece carrier frames 1 that are no longer needed can therefore be stored in a space-saving manner, in the disassembled state.

FIG. 3 shows the workpiece carrier frame 1 from FIG. 1 in a workpiece carrier basket 15. Carrier bottoms 17 are inserted into the workpiece carrier frame 1, and workpiece carriers 21 with workpieces 19 are arranged on these bottoms.

The workpiece holders 21 are arranged in a grid shape on the carrier bottoms 17. Multiple carrier bottoms 17 with workpiece holders 21 and workpieces 19 can be stacked one on top of the other, and can be inserted into the workpiece carrier frames 1. In this exemplary embodiment, two carrier bottoms 17 with workpiece carriers 21 and workpieces 19 are stacked on top of one another in the workpiece carrier basket 15. The lower workpiece carrier bottom 17 rests on the supports 11 of the frame corner modules 3 and of the side modules 7. The frame corner modules 3 and side modules 7 that project perpendicularly upward support the stacked carrier bottoms 17 and prevent them from sliding off to the side, without being firmly connected to them. In an alternative exemplary embodiment, the lower carrier bottom 17 is firmly but releasably connected to the workpiece carrier frame 1.

The top side of the workpiece carrier basket 15 can be covered with a lid 23, which can be set onto the workpiece carrier frame 1, so that it engages between the edge regions 13 of the frame corner modules 3 and the side modules 7. Alternatively, the lid 23 can be set onto the upwardly projecting workpiece carriers 21 or onto upwardly projecting handles of the upper carrier bottom 17, and rests on them.

Furthermore, a base 25 is provided, on which the workpiece carrier basket 15 can be positioned, so that an underside of the workpiece carrier basket 15 is also accessible. The base 25 can hold the workpiece carrier basket 15 in a production station, for example, and predetermine the position in which the workpiece carrier basket 15 is to be placed in the production station. Such a base 25 is used, for example, in a cleaning system, so that the cleaning fluid can flow away downward out of the workpiece carrier basket 15.

The top side of the base 25 has a circumferential stacking edge 27 into which the bottom sides of the frame corner modules 3 and of the side modules 7 engage with shape fit, so that the workpiece carrier basket 15 is secured to prevent it from sliding off to the side.

FIG. 4 shows an exemplary embodiment of fifteen workpiece carrier baskets 15, as described in connection with FIG. 3, which are stacked in five stacks of three workpiece carrier baskets 15 each. The workpiece carrier baskets 15 have the same size and each comprise a workpiece carrier frame 1 and carrier bottoms 17 with workpiece carriers 21 and workpieces 19. The contents of the workpiece carrier baskets 15 can differ with regard to the number of carrier bottoms 17 as well as the type of workpieces 19 and the workpiece holders 21. Lids 23 are set onto the uppermost workpiece carrier baskets 15 of the stacks.

The longitudinal sides and width sides of the workpiece carrier baskets 15 have a ratio of 3:2, so that three stacks that are arranged next to one another at their longitudinal sides and two stacks that are arranged on the width sides of the other stacks with their longitudinal sides can be arranged on a rectangular surface, as shown in FIG. 3. The workpiece carrier baskets 15 can therefore be arranged, in a compact and space-saving manner, on a base 25 configured as a pallet, so that they can be transported together on the pallet.

It is also possible to stack workpiece carrier baskets 15 of different sizes one on top of the other. Thus, first workpiece carrier baskets 15 and second workpiece carrier baskets 15 that are twice as large can be stacked in that two first workpiece carrier baskets 15 are arranged next to one another and stacked on a second workpiece carrier basket 15. The longitudinal sides of the first workpiece carrier baskets 15 run parallel to the width sides of the second workpiece carrier basket 15. The bottom engagements 33 on the frame corner modules of the first workpiece carrier baskets 15 lie on the top sides of the frame corner modules and of the side modules 7 of the first workpiece carrier basket 15.

FIG. 5 shows an exemplary embodiment having multiple workpiece carrier frames 1, some of which are firmly connected to one another.

A workpiece carrier frame arrangement 43 comprises eight workpiece carrier frames 1, for example, which are connected to one another. The workpiece carrier frames 1 are arranged in two rows of four workpiece carrier frames 1 each, with their longitudinal sides adjacent. The adjacent frame corner modules 3 of two adjacent workpiece carrier frames 1 are firmly but releasably connected to one another, for example by means of suitable connection means. The adjacent side modules 7 of two adjacent workpiece carrier frames 1 are also firmly but releasably connected to one another. In this manner, two frame corner modules 3 are connected to one another on the outer sides of the workpiece carrier frame arrangement 43. In the interior of the workpiece carrier frame arrangement 43, four frame corner modules 3 are connected to one another, so that their outer edges face one another. The connection elements 5 in the interior of the workpiece carrier frame arrangement 43 are arranged in a lattice shape, by means of the workpiece carrier frames 1 that are connected to one another.

In the lattice-shaped workpiece carrier frame arrangement 43, carrier bottoms 17 with workpiece carrier holders 21 and workpieces 19 can be used both next to one another and stacked on top of one another. By means of stacked workpiece carrier frame arrangements 43, it is possible to transport a plurality of workpieces 19 at the same time, in a simpler manner than in the case of individual workpiece carrier baskets 1, and processed in the production stations.

FIGS. 6A, 6B, and 6C show an exemplary embodiment of a frame corner module 3 in a side view, a front view, and a top view, respectively.

The frame corner module 3 has an angular basic shape, the legs of which meet one another at a right angle. The frame corner module 3 comprises an inner element 29 and an outer element 31, which are formed from plastic as separate one-piece injection-molded parts. The inner element 29 and the outer element 31 each have an angular basic shape. On a bottom side of the inner element 29, a support 11 for a carrier bottom 17 projects inward at a right angle to the legs.

The outer element 31 and the inner element 29 are put together and releasably connected to one another, so that they are arranged axially offset from one another. A region of the outer element 31 projects beyond the inner element 29 on the top side and forms an upper edge region 13 of a first stacking edge. A region of the inner element 29, which region projects beyond the outer element 31 on the underside, forms a bottom engagement 33 with a support 11 that projects inward as a second stacking edge. The bottom engagement 33 and the edge region 13 of a further frame corner module 3 engage into one another as corresponding first and second stacking edges, so that the bottom engagement 33 is secured to prevent any movement outward. In order for the edge region 13 and the bottom engagement 33 to have sufficient play when workpiece carrier baskets 15 are stacked, the region of the outer element 31 that projects beyond the inner element 29 on the top side is slightly set back outward.

The side walls of the inner element 29 and of the outer element 31 that lie on top of one another have projecting ridges 35 and corresponding grooves 37, respectively, which align the inner element 29 and the outer element 31 when they are put together, so that the bottom engagement 33 and the frame region 13 engage, with shape fit, with the frame region 13 and bottom engagement 33 of a further frame corner module 3. Alternative coding means, so as to predetermine the orientation with a predetermined offset when putting together the inner element 29 and the outer element 31 are conceivable.

Two k recesses 39 having a circular cross-section are provided in the legs of the frame corner module 3, in each instance, to hold the module frames 5. The recess 39 runs parallel between the inner side and the outer side of the leg and is formed by means of semi-circular channels in the inner element 29 and in the outer element 31, wherein the channels form the circular recess 39 when the inner element 29 and the outer element 31 are assembled. The shape and the diameter of the recess 39 correspond to the shape and the diameter of the module frame 5.

The inner element 29 and the outer element 31 are releasably connected to one another, for example by means of connection means 41, in particular connection means that can be screwed together. The inner element 29 and the outer element 31 have continuous recesses with depressions, so that they can be connected to one another by means of a countersunk screw/screw nut connection. Alternatively, for example, a screw/cap nut connection can be provided.

The recesses for the connection means 41 can be used so as to merely connect the inner element 29 and the outer element 31 of the same frame corner module 3. Alternatively, they can also be used to connect multiple frame corner modules 41 of a workpiece carrier frame arrangement 43.

FIGS. 7A, 7B, and 7C show an exemplary embodiment of a side module 7 in a side view, a front view, and a top view, respectively.

The side module 7 has a rectangular basic shape, the inner side and outer side of which are widened at the top. The side module 7 comprises an inner element 29 and an outer element 31, which face the frame interior and face away from the frame interior, respectively, in the workpiece carrier frame 1. The inner element 29 and the outer element 31 are formed from plastic as separate one-piece injection-molded parts. The outer element 31 is flat. The inner element 29 has a support 11 for the carrier bottom 17, which support extends at a right angle into the frame interior, so that the element is L-shaped in a side view. The outer element 31 and the inner element 29 are releasably connected to one another. They are arranged offset from one another, so that a region of the outer element 31 projects beyond the inner element 29 on the top side and forms an upper edge region 13 of the first stacking edge. A region of the inner element 29 projects beyond the outer element 31 on the bottom side as a bottom engagement 33 and extends into the frame interior as the support 11. The bottom engagement 33 and the upper edge region 13 of a further side module 7 engage into one another with shape fit, as the first and second stacking edges, so that the bottom engagement 33 is secured to prevent movement toward the outside. In order for the edge region 13 and the projecting bottom engagement 33 to have sufficient play, the region of the outer element 31 that projects beyond the inner element 29 on the top side is set back slightly toward the outside. Instead of the bottom engagement 33 of a side module 7, the bottom engagement 33 of a frame corner module 3 can be set down on the top side of the side module 7. This occurs, for example, when smaller workpiece carrier baskets 15 are stacked next to one another on a larger workpiece carrier basket 15.

The side walls of the inner element 29 and of the outer element 31 that lie on top of one another have projecting ridges 35 or corresponding grooves 37, respectively, which align the inner element 29 and the outer element 31 with offset when they are assembled, so that the bottom engagement 33 and the frame region 13 engage with shape fit into the frame region 13 and the bottom engagement 33, respectively, of a further side module 7.

In the side module 7, there are two straight, continuous, circular recesses 39 that run parallel between the inner side and the outer side. The recess 39 is formed by semi-circular channels in the inner element 29 and the outer element 31, so that the channels form the recess 39 having a circular cross-section when the inner element 29 and the outer element 31 are assembled. Their shape and diameter correspond to the shape and diameter of the module frame 5.

The inner element 29 and the outer element 31 are releasably connected to one another, for example by means of connection means 41, in particular connection means that can be screwed together, which run in continuous recesses having depressions, through the inner element 29 and the outer element 31.

During assembly of a workpiece carrier frame 1, the inner elements 29 and the outer elements 31 of the frame corner modules 3 are arranged on the inside and the outside, respectively, at the corners of the module frames 5, and connected to one another by means of the connection means 41. Optionally, the side modules 7 can be fastened in place by means of assembly of their inner elements 29 and outer elements 31 on the module frame 5.

The characteristics indicated above and in the claims as well as those that can be derived from the figures can be advantageously implemented both individually and in different combinations. The invention is not restricted to the exemplary embodiments that are described, but can be modified in many ways within the scope of the ability of a person skilled in the art.

### REFERENCE SYMBOLS

1 workpiece carrier frame
3 frame corner module
5 module frame
7 side module
9 label
11 support
13 edge region
15 workpiece carrier basket
17 carrier bottom
19 workpiece
21 workpiece carrier
23 lid
25 base
27 stacking edge
29 inner element
31 outer element
33 bottom engagement
35 ridge
37 groove
39 recess
41 connection means
43 workpiece carrier frame arrangement

1. A workpiece carrier frame (1) having
a plurality of frame corner modules (3), each comprising an inner element (29) and an outer element (31), and
at least one module frame (5) that laterally encloses an interior of the workpiece carrier frame (1),
wherein the frame corner modules (3) are arranged in corner regions of the workpiece carrier frame (1), so that the inner element (29) and the outer element (31) of each frame corner module (3) are arranged on the inner side and the outer side, respectively, of the at least one module frame (5), and the inner element (29) and the outer element (31) of the frame corner module (3) are releasably connected to one another, and the at least one module frame (5) runs between the inner element (29) and the outer element (31).

2. The workpiece carrier frame (1) according to claim 1,
wherein the at least one module frame (5) comprises a first module frame (5) and a second module frame (5) that are arranged one on top of the other, and the inner elements (29) and the outer elements (31) each have an upper and a lower region, and wherein the first module frame (5) runs between the upper regions of the inner elements (29) and the outer elements (31), and the second module frame (5) runs between the lower regions of the inner elements (29) and the outer elements (31).

3. The workpiece carrier frame (1) according to claim 1,
which has four corner regions and wherein the at least one module frame (5) is rectangular.

4. The workpiece carrier frame (1) according to claim 1,
wherein the at least one module frame (5) has a closed frame shape.

5. The workpiece carrier frame (1) according to claim 1,
having at least one side module (7) comprising an inner element (29) and an outer element (31), which are releasably connected to one another, wherein the side module (7) is arranged in a side region that extends between two adjacent corner regions, and the at least one module frame (5) runs between the inner element (29) and the outer element (31) of the side module (7).

6. The workpiece carrier frame (1) according to claim 1,
which can be stacked.

7. The workpiece carrier frame (1) according to claim 1,
wherein the frame corner modules (3) each comprise a support (11), so that a carrier bottom (17) can be set onto the supports (11).

8. The workpiece carrier frame (1) according to claim 1,
wherein the frame corner modules (3) each have a bottom side and an opposite top side, and wherein the top sides are configured as a first stacking edge and the bottom sides are configured as a second stacking edge, which, in the stacked state, engages into the first stacking edge of a further workpiece carrier frame (1) on which the workpiece carrier frame (1) is stacked, so that the workpiece carrier frame (1) is prevented from slipping off to the side.

9. The workpiece carrier frame (1) according to claim 8,
wherein the outer element (31) and the inner element (29) of the frame corner module (3) are arranged offset from one another, in such a way that a region of the outer element (31), which region projects beyond the inner element (29) on the top side, forms an upwardly projecting edge region (13) of the first stacking edge, and a region of the inner element (29), which projects beyond the outer element (31) on the bottom side, forms a bottom engagement (33) of the second stacking edge.

10. The workpiece carrier frame (1) according to claim 8,
wherein the at least one side module (7) has a bottom side and an opposite top side, which forms a region of the first stacking edge.

11. The workpiece carrier frame (1) according to claim 10,
wherein the outer element (31) and the inner element (29) of the side module (7) are arranged offset relative to one another, in such a manner that a region of the outer element, which region projects beyond the inner element (29) on the top side, forms an upwardly projecting edge region (13) of the first stacking edge.

12. The workpiece carrier frame (1) according to claim 1,
wherein releasable connection means (41), in particular screw-type connection means, connect the inner elements (29) and the outer elements (31).

13. The workpiece carrier frame (1) according to claim 1,
having a continuous recess (39) in the frame corner module (3), which is formed by means of channels in the inner element (29) and in the outer element (31), which channels face one another.

14. The workpiece carrier frame (1) according to claim 5,
wherein the at least one module frame (5) is configured to be metallic with a round or rectangular cross-section and/or the frame corner modules (3) are formed from plastic and/or the at least one side module (7) is formed from plastic.

15. A workpiece carrier frame (1) having
a plurality of side modules (7), each comprising an inner element (29) and an outer element (31), and
at least one module frame (5) that laterally encloses an interior of the workpiece carrier frame (1),
wherein the side modules (7) are arranged in side regions of the workpiece carrier frame (1), so that the inner element (29) and the outer element (31) of each side module (7) are arranged on the inner side and the outer side, respectively, of the at least one module frame (5), and the inner element (29) and the outer element (31) of the side module (7) are releasably connected to one another, and the at least one module frame (5) runs between the inner element (29) and the outer element (31).

16. A workpiece carrier frame system having a plurality of workpiece carrier frames (1) according to claim 1, which comprise first workpiece carrier frames (1), the at least one module frame (5) of which has a first size, and second workpiece carrier frames (1), the at least one module frame (5) of which has a second size, wherein at least two of the first workpiece carrier frames (1) can be stacked next to one another on one of the second workpiece carrier frames (1).
